(19) United States
(12) Patent Application Publication
(10) Pub. No.: US 2003/0211019 A1
(43) Pub. Date: Nov. 13, 2003

(54) Purification of engine bleed air

(75) Inventors: Peter M. Michalakos, Chicago, IL (US); Robert Tom, Redondo Beach, CA (US)

Correspondence Address: Honeywell International, Inc., Law Dept. AB2, P.O. Box 2245, Morristown, NJ, 07962-9806, US

(73) Assignee: Honeywell International Inc., Morristown, NJ

(21) Appl. No.: 10/401,897

(22) Filed: Mar. 28, 2003

Related U.S. Application Data
(63) Continuation-in-part of application No. 10/115,180, filed on Apr. 1, 2002.

(51) Int. Cl. B01D 53/34; F01N 3/10; F01N 3/28

(52) U.S. Cl. 422/177; 423/248; 423/241; 423/210; 422/171; 422/173

(57) ABSTRACT

A method of purifying bleed air from an engine heats the bleed air only to an extent necessary for the bleed air to react under catalysis from a noble-metal-based reactor bed, converting the contaminants to filterable form. The contaminants are then removed with a post-treatment filter. A purifier functioning according to the present invention, which heats the bleed air to a temperature no greater than 450° F. which it attains without a combustor, thus releases less heat to adjoining components than a prior-art purifier, and outputs, purified air at a lower temperature than does a prior-art purifier, which typically needs to include a combustor. The purified air is sufficiently-cool as to be suitable for immediate release into interior compartments occupied by humans or the air conditioning system. Contaminants within the exhaust stream may be removed by a reactor bed either within the heat exchanger or separate from the heat exchanger, to produce a purified exhaust gas that may be released to the atmosphere with less environmental impact.

This application is a continuation-in-part of Ser. No. 10/115,180, filed Apr. 1, 2002.

### BACKGROUND OF THE INVENTION

The present invention generally relates to purification of air and, more specifically, to the purification of bleed air from combustion engines and to the purification of the exhaust of an auxiliary power unit (APU).

Modern large aircraft typically include, in addition to the main engines, APUs which are used primarily during taxiing, takeoff, or landing, or while the aircraft is standing at the gate. In operation, APUs may produce exhaust gas and bleed air. Exhaust gas is typically conducted to the outside, but bleed air may find its way to the aircraft's interior (which may include the passenger, crew, and cargo compartments). The bleed air may contain contaminants that originate from the APU itself or in the inlet air to the APU. Typically, these compounds are organic, and may include aviation lubricant, including its additives and breakdown products, for example aldehydes and esters; jet fuel; deicing fluid; engine exhaust; and hydraulic fluid. These compounds in the APU bleed air may reach the aircraft cabin and be objectionable as odors or smoke. This phenomenon is often termed “smell-in-cabin” or “smoke-in-cabin” (SIC).

The exhaust gas from the APU may contain emissions that are harmful to the environment. The APU exhaust gas may contain contaminants such as nitrogen oxides, carbon monoxide and hydrocarbons.

Methods of removing impurities from air are generally known in the prior art. For example, U.S. Pat. No. 5,294,410 to White teaches a system for removing impurities (primarily biological and chemical warfare impurities) from ambient air. White's system employs a gas turbine for compressing the gas and a combustor for combusting it, whereby operation is at a high temperature. The hot gas is first treated by a reactor bed of aluminum oxide to “crack” the larger target compounds, and then by a reactor bed of copper oxide to oxidize the cracked larger compounds and the remaining compounds. These kinds of reactor beds require that the gas be at a high temperature.

Unfortunately, the past methods and devices have several drawbacks. One is that the required operating temperatures are high. This requires that a combustion source be present, as Well as heat exchangers to eventually cool the bleed air to a temperature that can be safely processed by the aircraft's air conditioning system or inserted into the aircraft's interior. Thus, the devices are large and heavy with too high a pressure drop and energy consumption. If the bleed air itself is heated by combustion, it will be contaminated with unburned fuel and by-products. In addition, heat transfer from such devices to adjoining components of the aircraft may be objectionable because of the safety impact.

As can be seen, there is a need for a system for purifying air that operates at relatively low temperatures and that releases purified air of a relatively low temperature.

### SUMMARY OF THE INVENTION

One aspect of the present invention provides a method in which bleed air from an engine is heated, reacted in a catalytic reactor to produce reacted contaminant components, and optionally filtered to remove the reacted contaminant components, thus producing purified air for release.

Another aspect of the present invention provides a method in which bleed air from an engine is heated to a temperature in the range of about 220-450° F., reacted in a catalytic reactor comprising a substrate coated with low-temperature catalyst to produce reacted contaminant components, and optionally filtered to remove the reacted contaminant components, thus producing purified air for release.

Another aspect of the present invention provides a method in which bleed air from an engine is heated to a temperature in the range of about 220-450° F. by heat exchanging with exhaust gas of the engine; reacted in a catalytic reactor comprising a substrate coated with a low-temperature catalyst to produce reacted contaminant components including carbon dioxide reacted from carbon-containing contaminants, water reacted from hydrogen-containing contaminants, acid gas or an acid-gas precursor reacted from heteroatom-containing contaminants, such as hydrochloric acid reacted from chlorine contaminants, nitric oxide, nitrous oxide, nitrogen dioxide, and nitrogen reacted from nitrogen-containing contaminants; and filtered to remove the reacted contaminant components, thus producing purified air for release.

Another aspect of the invention provides an apparatus for purifying bleed air from an engine which produces a bleed air stream and an exhaust gas stream, comprising a heat exchanger for exchanging heat from the exhaust stream to heat the bleed air to a temperature in the range of about 220-450° F.; a catalytic reactor comprising a substrate coated with a low-temperature catalyst to produce reacted contaminant components including carbon dioxide reacted from carbon contaminants, water reacted from hydrogen contaminants, acid gas or an acid-gas precursor reacted from heteroatom contaminants such as hydrochloric acid reacted from chlorine contaminants, and nitric oxide reacted from nitrogen contaminants; and a filter for removing the reacted contaminant components, thus producing purified air for release.

Another aspect of the present invention provides a method of purifying bleed air from an engine which produces a bleed air stream and an exhaust gas stream having a temperature warmer than the bleed air stream, the method comprising the steps of: heating the bleed air to produce heated bleed air to a temperature between 220° F. and 450° F. by placing the bleed air and the exhaust gas in thermal contact but not in fluid contact by flowing each through a different chamber of a heat exchanger; reacting the heated bleed air in a bleed air catalytic reactor bed comprising a noble metal catalyst supported on a washcoat of metal oxide to produce reacted bleed air in which; carbon contaminants in the heated bleed air are reacted to CO₂; hydrogen contaminants in the heated bleed air are reacted to H₂O; contaminating heteroatoms are reacted to one of an acid gas and an acid-gas precursor; chlorine contaminants in the heated bleed air are reacted to HCl, and nitrogen contaminants in the heated bleed air are reacted to at least one of dinitrogen, nitrous oxide, nitric oxide, and nitrogen dioxide; releasing the reacted bleed air; reacting the exhaust gas in an exhaust gas catalytic reactor bed to produce a purified exhaust gas; and releasing the purified exhaust gas.

These and other features, aspects and advantages of the present invention will become better understood with reference to the following drawings, description and claims.

### BRIEF DESCRIPTION OF THE DRAWINGS

FIG. 1 is a flow diagram of the method of the present invention;

FIG. 2 is a block diagram of one embodiment of an apparatus on which the method of the present invention may be practiced;

FIG. 3 is a block diagram of another embodiment of an apparatus on which the method of the present invention may be practiced;

FIG. 4 is a block diagram of yet another embodiment of an apparatus on which the method of the present invention may be practiced; and

FIG. 5 is a block diagram depicting variant embodiment details of an apparatus on which the method of the present invention may be practiced.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a system for purifying exhaust gases and bleed air from a combustion engine, the system operating at a relatively low temperature that enhances its suitability for placement proximate to other components, and that eliminates SIC events to enhance the usability by humans of the purified air. An embodiment of the system is for use in purifying the bleed air from auxiliary power units (APUs) employed aboard aircraft, but those skilled in the art will appreciate that the present invention may be useful with any engine producing a stream of bleed air and a hotter stream of exhaust. Aircraft APU systems must not excessively heat adjoining portions of the aircraft, lest those adjoining portions be impaired or damaged by excessive heat, and lest safety regulations be violated. Purified bleed air that may find its way into the aircraft's air conditioning system must not be so hot as to exceed the cooling capacity of the system or temperature limits of the construction material. Purified bleed air that may find its way into the aircraft's interior must not be so hot as to be uncomfortable or unsafe to passengers and crew. The benefit is that additional heat exchange is not required, saving weight, size, and pressure drop.

The bleed air purification system may employ a catalyst employing a noble metal in order to be effective at a temperature lower than systems of the prior art, temperatures in the range of 220-450° F. As a result, the system of the present invention does not require a combustor for heating the bleed air, but is able to obtain sufficient heat for its operation by heat-exchanging with the exhaust gas flow from the same APU from which the bleed air emanates.

Typically, noble metals including platinum, palladium, rhodium, silver, gold, iridium, may be supported on a high-surface area washcoat that has good adhesion to the substrate. The washcoat is typically a metal oxide such as alumina, titania, silica, zirconia, or other transition metal oxides or mixtures of these. The washcoat and catalyst have good adhesion such that there is no flaking, peeling, or loss of material in the operating environment of aircraft, including high vibrations. The adhesion may be ensured by proper formulation of the washcoat, as well as treatment of the substrate. The washcoat is applied as a slurry of the metal oxide, a binder, and solvent, as discussed in a related U.S. patent application, Ser. No. 101,140, filed Sep. 18, 1998, and which is incorporated herein by reference.

The exhaust stream purification system may be formed either as a unit separate from the bleed air purification system or within the same structural component as the bleed air purification system. The exhaust stream purification system may employ any conventional catalyst known to be effective at removing engine exhaust stream pollutants. For example, catalysts known as a “three-way conversion” or “TWC” catalysts may be useful in the present invention. TWC catalysts are polyfunctional in that they have the capability of substantially simultaneously catalyzing the oxidation of hydrocarbons and carbon monoxide and the reduction of nitrogen oxides. Conventional TWC catalysts which exhibit good activity and long life may include one or more platinum group metals (e.g., platinum or palladium, rhodium, ruthenium and iridium). The catalyst may be supported on a high-surface area washcoat similar to that used in the bleed air purification system described above. The support may be carried on a suitable carrier or substrate such as a monolithic carrier comprising a refractory ceramic or metal honeycomb structure, or refractory particles such as spheres or short, extruded segments of a suitable refractory material.

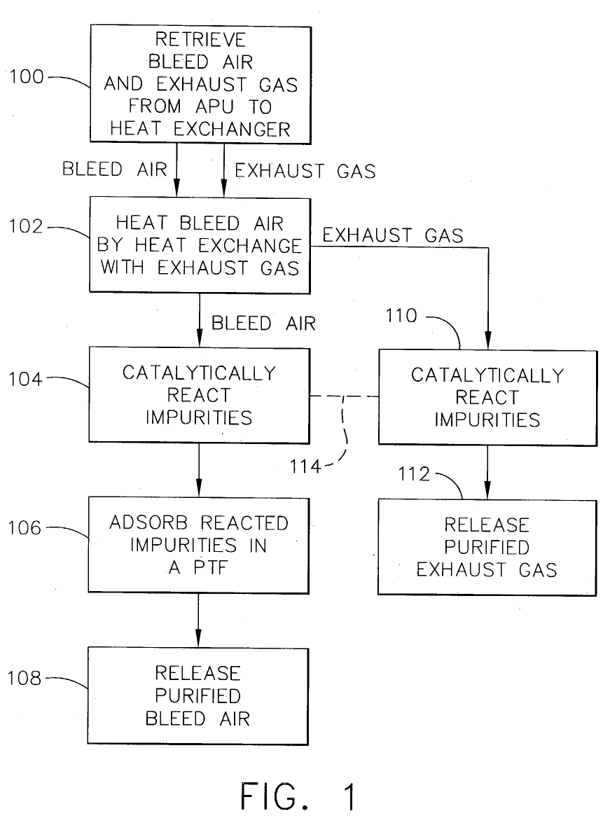

FIG. 1 depicts a high-level flow chart of the method of the present invention. Block 100 indicates that bleed air is retrieved from an APU into a heat exchanger. Following block 100 is block 102, which specifies that bleed air is heated therein by thermal contact through the heat exchanger with exhaust air from the APU. One skilled in the art may specify the parameters of the heat exchanger so that the temperature of the bleed air is elevated to a temperature in a predetermined range, such as between 220° F. and 450° F.

The bleed air from the APU may contain contaminants that originate within the APU itself or in the inlet air to the APU, including without limitation aviation lubricant (including its additives and breakdown products), jet fuel, deicing fluid, engine exhaust, and hydraulic fluid. Block 104, which follows block 102, indicates that the heated bleed air is passed through a reactor bed comprising a noble metal catalyst on a high-surface area washcoat with good adhesion to the substrate in order to induce reactions in which the carbon portion of contaminants reacts to carbon dioxide (CO₂), the hydrogen portion. reacts to water (H₂O), and the various heteroatoms to an acid gas or acid-gas precursor: for example, chlorine to hydrochloric acid (HCl) and nitrogen to such compounds as dinitrogen, nitrous oxide, nitric oxide, and nitrogen dioxide.

The exhaust gas may also contain contaminants from combustion, such as nitrogen oxides, carbon monoxide, and hydrocarbons. Block 110 indicates that the exhaust gas is catalytically treated to decompose the pollutants. The treated exhaust gas may then be released as purified exhaust gas, as indicated in block 112. The dotted line connecting block 110 and block 104 indicates that the treatment of the exhaust gas and the bleed air may take place in a single reactor in separate chambers.

After block 104, block 106 specifies that the bleed air passes through an optional post-treatment filter (PTF), which adsorbs the acidic reaction products. The PTF may be similar to that shown in related U.S. patent application, Ser. No. 823,623, filed Mar. 31, 2001, and incorporated herein by reference. Acid-gases are permanently adsorbed onto the surface. In block 108 the bleed air, purified after block 106, is released into the aircraft's air conditioning system before entering the aircraft interior. Some of the bleed air bypasses the air conditioning system and enters the aircraft interior directly. While the proportion of air entering the air conditioning system to the air entering the interior directly is determined by the desired temperature of the interior, both air streams are of sufficient purity and temperature as to be mixed safely. Because of the relatively low operating temperature of the present invention, less heat exchange is required before entering the air conditioning system of the aircraft. This results in reduced weight, volume, and pressure drop compared to the prior art. Also, it is not necessary to use all of the exhaust stream to heat the bleed air stream, which is safer and simpler than having to use all the exhaust stream. Those skilled in the art of heat transfer will appreciate that under these conditions the bleed air stream does not approach the temperature of the exhaust stream, while devices of the prior art operate at temperatures near that of the exhaust stream.

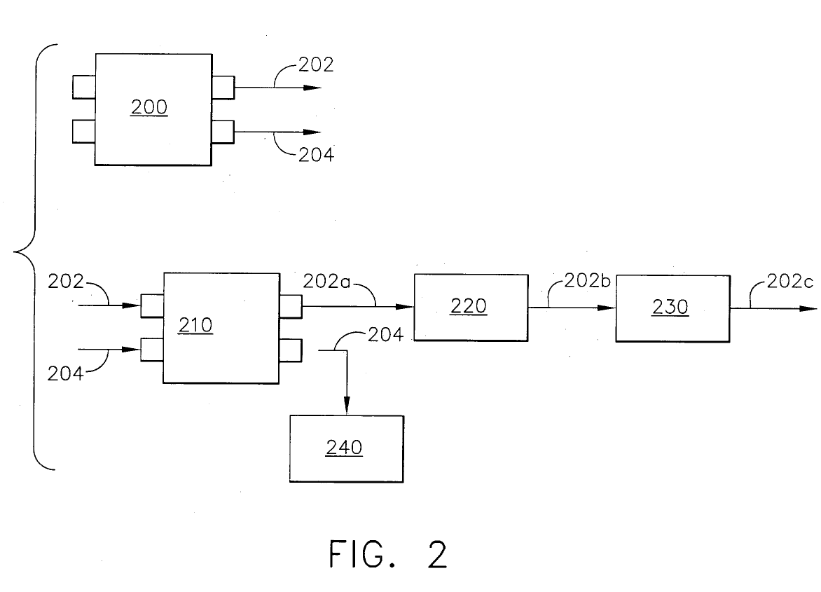

FIG. 2 is a block diagram of an apparatus on which the method of the present invention may be performed. An APU 200 produces a stream of bleed air 202 and exhaust stream 204, both of which enter a heat exchanger 210 in which they are in thermal contact but not in fluid contact. The temperature of exhaust stream 204 may be significantly higher than that of bleed air 202, so that the temperature of bleed air 202 may be increased in heat exchanger 210, and is referred to as heated bleed air 202a where it exits heat exchanger 210. Heated bleed air 202a traverses reactor bed 220 where, as previously noted, contaminants contained in it may be catalytically induced to undergo oxidation reactions. The bleed air stream bearing reacted contaminant components is designated reacted bleed air 202b where it exits reactor bed 220. Reacted bleed air 202b then traverses optional PTF 230. PTF 230 adsorbs the acidic reacted contaminant components from reacted bleed air 202b. The bleed air stream, designated purified bleed air 202c, is released from PTF 230 and may safely be introduced into the air conditioning system of an aircraft and the interior. An exiting exhaust stream 204a may be released directly to the atmosphere or optionally treated in a reactor bed 240 to remove pollutants prior to its release to the atmosphere.

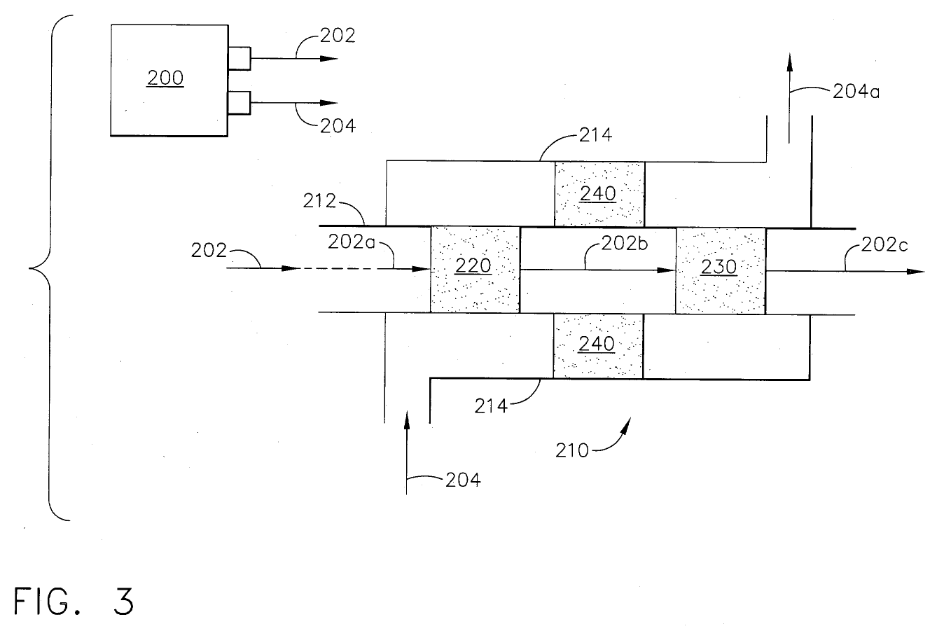

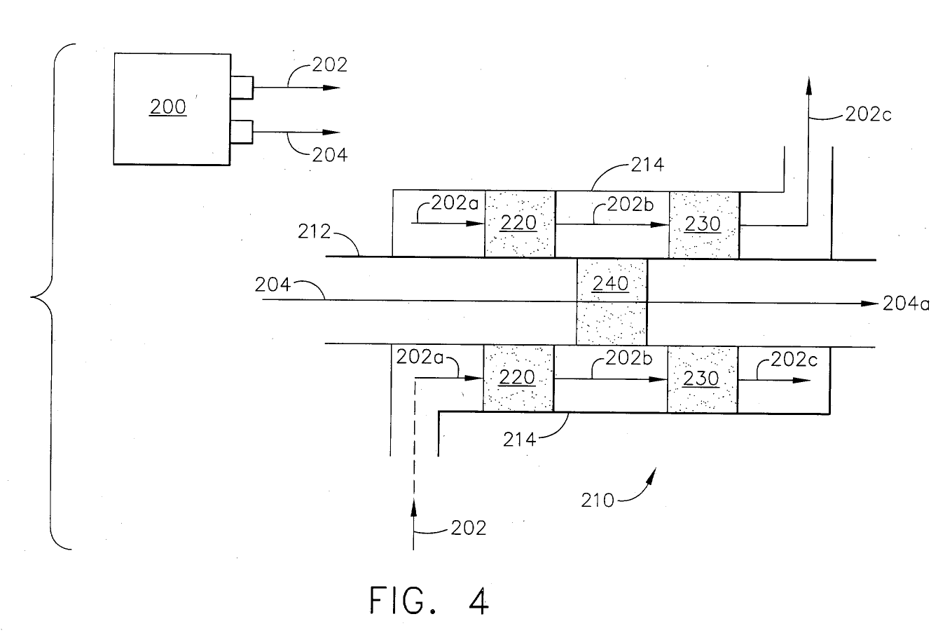

FIGS. 3 and 4 depict alternative apparatus in which the method of the present invention may be practiced, and in which the bleed air and exhaust stream reactor beds and optional PTF may be integral with heat exchanger 210. FIG. 3 shows a section through heat exchanger 210 which comprises a central passage 212 traversing an outer chamber 214. Bleed air 202 may be introduced into central passage 212, while exhaust stream 204 traverses outer chamber 214. Bleed air 202 and exhaust stream 204 are thus in thermal but not fluid contact through walls of central passage 212, and bleed air 202 may be heated. Reactor bed 220 and PTF 230 may be positioned within central passage 212. Bleed air 202 thus becomes heated into heated bleed air 202a, such as at 220° F. to 450° F., catalytically reacted by reactor bed 220 into reacted bleed air 202b, and optionally filtered by PTF 230 into purified bleed air 202c which may be released, and may be introduced into the air conditioning system or interior of an aircraft. Exhaust stream 204 may be catalytically reacted by reactor bed 240 within heat exchanger 210 to produce a purified exhaust gas stream 204a. Reactor bed 240 may be positioned at any location within outer chamber 214 of heat exchanger 210.

FIG. 4 also shows a section through a heat exchanger 210 comprising a central passage 212 traversing an outer chamber 214. In this embodiment, bleed air 202 may be conducted into outer-chamber 214 and exhaust stream 204 is conducted into central passage 212. Reactor bed 220 and PTF 230 may be arranged so that gas passing through the outer chamber 214 passes through reactor bed 220 and PTF 230. Thus, comparable to the operation described in connection with FIG. 3, bleed air 202 may be heated to become heated bleed air 202a, may be reacted to become reacted bleed air 202b, and may be filtered to become purified bleed air 202c for release. Exhaust stream 204 may be catalytically reacted by reactor bed 240 within heat exchanger 210 to produce a purified exhaust gas stream 204a. Reactor bed 240 may be positioned at any location within inner chamber 212 of heat exchanger 210.

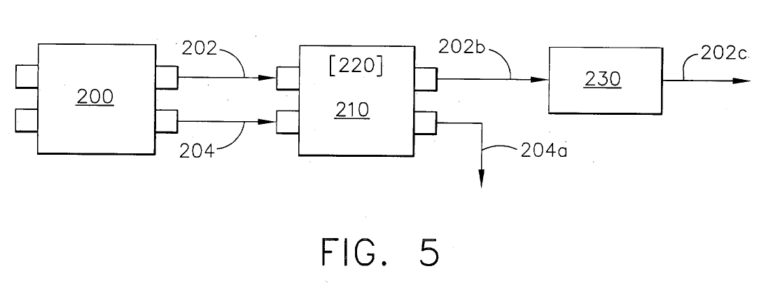

FIG. 5 shows another embodiment, in which the catalyst and washcoat 220 is deposited on the surfaces of heat exchanger 210 through which flow bleed air stream 202. As the bleed air stream 202 is heated in heat exchanger 210 by heat exchanging with exhaust stream 204, the contaminants are reacted as previously described to produce reacted bleed air 202b. Reacted bleed air 202b may then optionally be filtered by PTF 230 to produce purified bleed air 202c. Alternatively, PTF 230 may also be deposited on the surfaces of heat exchanger 210 through which flows bleed air stream 202. Similiarly, as exhaust stream 204 passes through heat exchanger 210, the contaminants therein are reacted as previously described to produce purified exhaust stream 204a.

As can be appreciated by those skilled in the art, the present invention provides an improved apparatus and method for purifying air that operates at relatively low temperatures and that releases purified air of a relatively low temperature.

It should be understood, of course, that the foregoing relates to preferred embodiments of the invention and that modifications may be made without departing from the spirit and scope of the invention as set forth in the following claims.

We claim:

1. A method of purifying air, comprising the steps of:
heating the air to produce heated air;
reacting the heated air in a heated air catalytic reactor bed to produce reacted air containing reacted contaminant components; and
releasing the reacted air.

2. The method of claim 1, wherein, in the heating step, the air is heated to a temperature between 220° F. and 450° F.

3. The method of claim 2, wherein the reactor bed comprises an oxidation catalyst including a noble metal supported on a high-surface metal oxide.

4. The method of claim 3, wherein, in the reacting step, carbon in the contaminants in the heated air is reacted to CO₂.

5. The method of claim 3, wherein, in the reacting step, hydrogen in the contaminants in the heated air is reacted to H₂O.

6. The method of claim 3, wherein, in the reacting step, contaminating heteroatoms are reacted to one of an acid gas and an acid-gas precursor.

7. The method of claim 6, wherein, in the reacting step, chlorine contaminants in the heated air are reacted to HCl.

8. The method of claim 6, wherein, in the reacting step, nitrogen contaminants in the heated air are reacted to at least one of dinitrogen, nitrous oxide, nitric oxide, and nitrogen dioxide.

9. The method of claim 1, wherein the air comprises bleed air from an engine which also produces a stream of exhaust gas hotter than the bleed air, wherein the heating step comprises placing the bleed air and at least a portion of the exhaust gas in thermal contact but not in fluid contact.

10. The method of claim 9, further comprising:
reacting the exhaust gas in an exhaust gas catalytic reactor bed to produce a purified exhaust gas; and
releasing the purified exhaust gas.

11. The method of claim 9, wherein the placing of the bleed air and the exhaust gas in thermal contact is performed by flowing each through a different chamber of a heat exchanger.

12. The method of claim 1 further including the step, before the step of releasing the reacted air, of filtering from the reacted air with a filter the reacted contaminant components produced in the reacting step.

13. The method of claim 12, wherein the heated air catalytic reactor bed and the filter are positioned externally to the heat exchanger.

14. The method of claim 12, wherein the heated air catalytic reactor bed and the filter are positioned within the heat exchanger chamber through which the bleed air is flowed.

15. The method of claim 12, wherein the heated air catalytic reactor bed is positioned within the heat exchanger chamber through which the bleed air is flowed and the filter is positioned externally to and downstream of the heat exchanger.

16. A method of purifying bleed air from an engine, comprising the steps of:
heating the bleed air to produce heated bleed air at a temperature between 220° F. and 450° F.;
reacting the heated bleed air in a bleed air catalytic reactor bed comprising a noble metal catalyst supported on a washcoat of metal oxide to produce reacted bleed air containing reacted contaminant components; and
releasing the reacted bleed air.

17. The method of claim 16, wherein in the reacting step:
carbon contaminants in the heated bleed air are reacted to CO₂;
hydrogen contaminants in the heated bleed air are reacted to H₂O;
contaminating heteroatoms are reacted to one of an acid gas and an acid-gas precursor;
chlorine contaminants in the heated bleed air are reacted to HCl, and
nitrogen contaminants in the heated bleed air are reacted to at least one of dinitrogen, nitrous oxide, nitric oxide, and nitrogen dioxide.

18. The method of claim 16, wherein the bleed air from an engine produces a stream of exhaust gas hotter than the bleed air, wherein the heating step comprises placing the bleed air and the exhaust gas in thermal contact but not in fluid contact by flowing each through a different chamber of a heat exchanger.

19. The method of claim 18, further comprising:
reacting the exhaust gas in an exhaust gas catalytic reactor bed to produce a purified exhaust gas; and
releasing the purified exhaust gas.

20. The method of claim 16, further comprising, before the step of releasing the reacted bleed air, the step of filtering from the reacted bleed air with a filter the reacted contaminant components produced in the reacting step.

21. The method of claim 20, wherein the bleed air catalytic reactor bed and the filter are positioned externally to the heat exchanger.

22. The method of claim 20, wherein the bleed air catalytic reactor bed and the filter are positioned within the heat exchanger chamber through which the bleed air is flowed.

23. The method of claim 20, wherein the bleed air catalytic reactor bed is positioned within the heat exchanger chamber through which the bleed air is flowed and the filter is positioned externally to and downstream of the heat exchanger.

24. The method of claim 23, further comprising:
reacting the exhaust gas in an exhaust gas catalytic reactor bed to produce a purified exhaust gas; and
releasing the purified exhaust gas.

25. A method of purifying bleed air from an engine which produces a bleed air stream and an exhaust gas stream, the method comprising the steps of:
heating the bleed air to produce heated bleed air to a temperature between 220° F. and 450° F. by placing the bleed air and the exhaust gas in thermal contact but not in fluid contact by flowing each through a different chamber of a heat exchanger;
reacting the heated bleed air in a bleed air catalytic reactor bed comprising a noble metal catalyst supported on a washcoat of metal oxide to produce reacted bleed air in which;
carbon contaminants in the heated bleed air are reacted to CO₂;
hydrogen contaminants in the heated bleed air are reacted to H₂O;
contaminating heteroatoms are reacted to one of an acid gas and an acid-gas precursor;
chlorine contaminants in the heated bleed air are reacted to HCl, and
nitrogen contaminants in the heated bleed air are reacted to at least one of dinitrogen, nitrous oxide, nitric oxide, and nitrogen dioxide;
and releasing the reacted bleed air.

26. The method of claim 25 wherein the bleed air from an engine produces a stream of exhaust gas hotter than the bleed air, wherein the heating step comprises placing the bleed air and the exhaust gas in thermal contact but not in fluid contact by flowing each through a different chamber of a heat exchanger.

27. The method of claim 25, further comprising:
reacting the exhaust gas in an exhaust gas catalytic reactor bed to produce a purified exhaust gas; and
releasing the purified exhaust gas.

28. The method of claim 25 further comprising the step, before the step of releasing the reacted bleed air, of filtering in a filter components produced in the reacting step from the reacted bleed.

29. The method of claim 28, wherein the bleed air catalytic reactor bed, the exhaust gas catalytic reactor bed and the filter are positioned externally to the heat exchanger.

30. The method of claim 28, wherein the bleed air catalytic reactor bed, the exhaust gas catalytic reactor bed and the filter are positioned within the heat exchanger chamber through which the bleed air is flowed.

31. The method of claim 28, wherein the bleed air catalytic reactor bed and the exhaust gas catalytic reactor bed is positioned within the heat exchanger chamber through which the bleed air is flowed and the filter is positioned externally to and downstream of the heat exchanger.

32. Apparatus for purifying bleed air from an engine which produces a bleed air stream and an-exhaust gas stream, the apparatus comprising:
a heat exchanger for heating the bleed air to produce heated bleed air at a temperature between 220° F. and 450° F. by placing the bleed air and the exhaust gas in thermal contact but not in fluid contact by flowing each through a different chamber of a heat exchanger; and
a bleed air catalytic reactor bed comprising a noble metal catalyst supported on a washcoat of metal oxide for reacting the heated bleed air to produce reacted bleed air in which;
carbon contaminants in the heated bleed air are reacted to CO₂;
hydrogen contaminants in the heated bleed air are reacted to H₂O;
contaminating heteroatoms are reacted to one of an acid gas and an acid-gas precursor;
chlorine contaminants in the heated bleed air are reacted to HCl, and
nitrogen contaminants in the heated bleed air are reacted to at least one of dinitrogen, nitrous oxide, nitric oxide, and nitrogen dioxide.

33. The apparatus of claim 32, further comprising:
an exhaust gas catalytic reactor bed for reacting said exhaust gas to produce a purified exhaust gas; and
releasing the purified exhaust gas.

34. The apparatus of claim 32, further comprising a filter for filtering components produced in the reactor bed.

35. The apparatus of claim 34, wherein the bleed air catalytic reactor bed, the exhaust gas catalytic reactor bed and the filter are positioned externally to the heat exchanger.

36. The apparatus of claim 34, wherein the bleed air catalytic reactor bed, the exhaust gas catalytic reactor bed and the filter are positioned within the heat exchanger chamber through which the bleed air is flowed.

37. The apparatus of claim 34, wherein the bleed air catalytic reactor bed and the exhaust gas catalytic reactor bed is positioned within the heat exchanger chamber through which the bleed air is flowed and the filter is positioned externally to and downstream of the heat exchanger.

38. A method of purifying bleed air from an engine which produces a bleed air stream and an exhaust gas stream having a temperature warmer than the bleed air stream, the method comprising the steps of:
heating the bleed air to produce heated bleed air to a temperature between 220° F. and 450° F. by placing the bleed air and the exhaust gas in thermal contact but not in fluid contact by flowing each through a different chamber of a heat exchanger;
reacting the heated bleed air in a bleed air catalytic reactor bed comprising a noble metal catalyst supported on a washcoat of metal oxide to produce reacted bleed air in which;
carbon contaminants in the heated bleed air are reacted to CO₂;
hydrogen contaminants in the heated bleed air are reacted to H₂O;
contaminating heteroatoms are reacted to one of an acid gas and an acid-gas precursor;
chlorine contaminants in the heated bleed air are reacted to HCl, and
nitrogen contaminants in the heated bleed air are reacted to 20 at least one of dinitrogen, nitrous oxide, nitric oxide, and nitrogen dioxide;
releasing the reacted bleed air;
reacting the exhaust gas in an exhaust gas catalytic reactor bed to produce a purified exhaust gas;
releasing the purified exhaust gas.

39. The method of claim 38, further comprising the step, before the step of releasing the reacted bleed air, of filtering in a filter components produced in the reacting step from the reacted bleed.

40. The method of claim 39, wherein the bleed air catalytic reactor bed, the exhaust gas catalytic reactor bed and the filter are positioned externally to the heat exchanger.

41. The method of claim 39, wherein the bleed air catalytic reactor bed, the exhaust gas catalytic reactor bed and the filter are positioned within the heat exchanger chamber through which the bleed air is flowed.

42. The method of claim 39, wherein the bleed air catalytic reactor bed and the exhaust gas catalytic reactor bed is positioned within the heat exchanger chamber through which the bleed air is flowed and the filter is positioned externally to and downstream of the heat exchanger.
